(19) United States
(12) Patent Application Publication
(10) Pub. No.: US 2021/0031949 A1
(43) Pub. Date: Feb. 4, 2021

(54) Low Earth Orbit Neutral Impulse Defense And Salvage (LEONIDAS) Launch System And Method Of Fabrication

(71) Applicant: MolyWorks Materials Corporation, Los Gatos, CA (US)

(72) Inventors: Stephen Bartholomaei, Castro Valley, CA (US); ANDREW VanOs LaTOUR, Hayward, CA (US)

(73) Assignee: MolyWorks Materials Corporation, Los Gatos, CA (US)

(21) Appl. No.: 16/922,076

(22) Filed: Jul. 7, 2020

Related U.S. Application Data
(60) Provisional application No. 62/872,326, filed on Jul. 10, 2019.

(51) Int. Cl. B64G 1/00; B64G 1/44

(52) U.S. Cl. CPC B64G 1/007; B64G 2001/643; B64G 1/44

(57) ABSTRACT

A low Earth orbit neutral impulse defense and salvage (LEONIDAS) launch system includes a base having multiple flexible limbs including cross-bow limbs and recoil limbs. The LEONIDAS launch system also includes a solar powered mechanical drive system on the base configured to position the flexible limbs in desired positions and a rotary magazine on the base configured to hold multiple sub-vessels that are configured to perform different activities in space such as defense and salvage. The LEONIDAS launch system also includes one or more launch cables attached to the cross-bow limbs configured to impart the launch power to the sub-vessels during launch into low earth orbits.

### CROSS REFERENCE TO RELATED APPLICATION

This application claims priority from U.S. Provisional No. 62/872,326, filed Jul. 10, 2019, which is incorporated herein by reference.

### FIELD

This disclosure relates to a low Earth orbit launch system for performing various operations in space.

### BACKGROUND

The region of outer space close to Earth swarms with satellites and millions of pieces of man made debris in low Earth orbit (LEO). The management and defense of this region has national security implications for all countries. One proposed concept involves low Earth orbit (LEO) launch systems designed to operate as platforms for launching sub-launch vessels into space for performing different activities. The present disclosure is directed to a low Earth orbit (LEO) launch system that can be used for salvage, asset defense, orbit modification, active debris removal and counter ICBM activities.

### SUMMARY

A low Earth orbit neutral impulse defense and salvage (LEONIDAS) launch system includes a base having multiple flexible limbs including cross-bow limbs and recoil limbs. The LEONIDAS launch system also includes a solar powered mechanical drive system on the base configured to position the flexible limbs in desired positions and a rotary magazine on the base configured to hold multiple sub-vessels that are configured to perform different activities in space such as defense and salvage. The LEONIDAS launch system also includes one or more launch cables attached to the cross-bow limbs configured to impart the launch power to the sub-vessels during launch into low earth orbits.

In an illustrative embodiment the flexible limbs comprise a nickel-titanium alloy and are made using an additive manufacturing process. During a launch mode, the cross-bow limbs are configured to generate launch power and the recoil limbs are configured to eliminate recoil by balancing momentum transfer for launching the sub-vessels. The flexible limbs can be positioned by the mechanical drive system during the launch mode such that all force vectors are neutralized maintaining a neutral impulse for the base. At least some of the flexible limbs can also be configured as propulsion limbs for generating locomotion in space by contraction then energy release in the desired direction of travel.

The flexible limbs can be initially cocked in the launch mode to permit loading of a sub-vessel into position for launching. During the launch mode, limb motion is symmetrical with respect to an axis perpendicular to a launch direction, but asymmetrical with respect to a launch axis. This allows the LEONIDAS launch system to counteract the effect of launching the sub-vessels, resulting in a launch with minimal recoil. The concept is termed herein limb actuated inertial reflex (LAIR).

A method for fabricating the LEONIDAS launch system includes the steps of: producing a nickel-titanium alloy powder from scrap material, and producing a base comprised of flexible limbs having a desired configuration using the alloy powder and an additive manufacturing system, the flexible limbs including cross-bow limbs, recoil limbs and propulsion limbs.

### BRIEF DESCRIPTION OF THE DRAWINGS

Exemplary embodiments are illustrated in the referenced figures of the drawings. It is intended that the embodiments and the figures disclosed herein be to be considered illustrative rather than limiting.

FIG. 1 is a schematic perspective view of a LEONIDAS launch system;

FIG. 2 is a front elevation view of a prototype LEONIDAS launch system;

FIG. 3 is a schematic view of a rotary magazine for the LEONIDAS launch system;

FIG. 4 is a schematic view of a salvage sub-vessel for the LEONIDAS launch system;

FIG. 5 is a flow diagram illustrating an operational method for the LEONIDAS launch system;

FIG. 6 is a schematic view of solar panels and flexible solar panel limbs of the LEONIDAS launch system;

FIG. 7 is a schematic view of flexible propulsion limbs of the LEONIDAS launch system; and

FIG. 8 is a schematic view of a salvage activity performed using a salvage sub-vessel of the LEONIDAS launch system.

### DETAILED DESCRIPTION

A low Earth orbit (LEO) refers to an Earth centered orbit with an altitude of 2000 km (1200 miles) or less. As used herein, the term LEONIDAS stands for low Earth orbit neutral impulse defense and salvage launch system. The term LAIR stands for limb actuated inertial reflex. NITONAL comprises a nickel-titanium alloy distinguished from other materials by its shape memory and superelastic characteristics. NITINOL is a trade name taken from the elements it's composed of—nickel (Ni) and titanium (Ti)—and the scientific group that discovered it—the Naval Ordnance Laboratory (NOL).

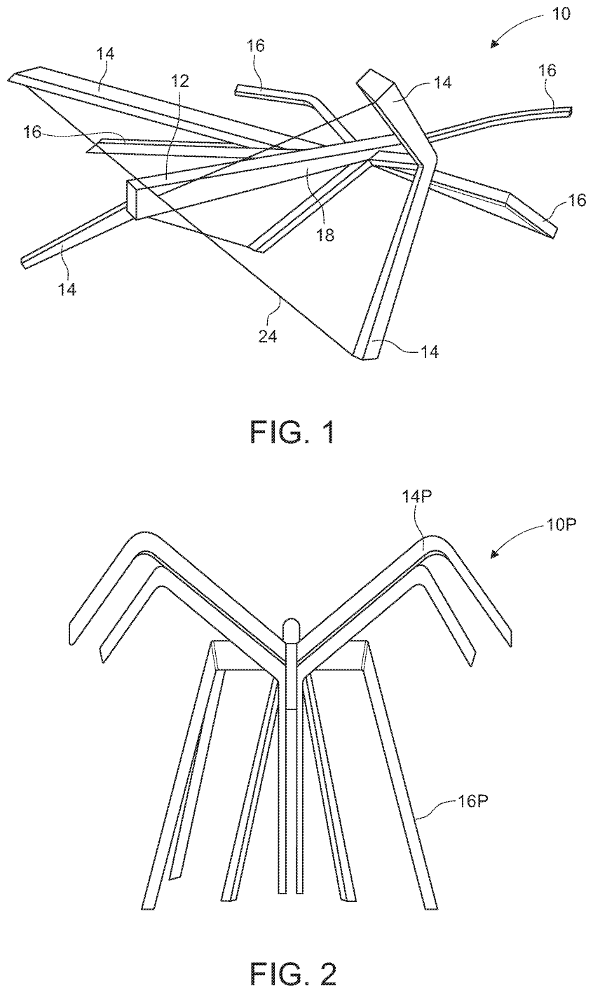

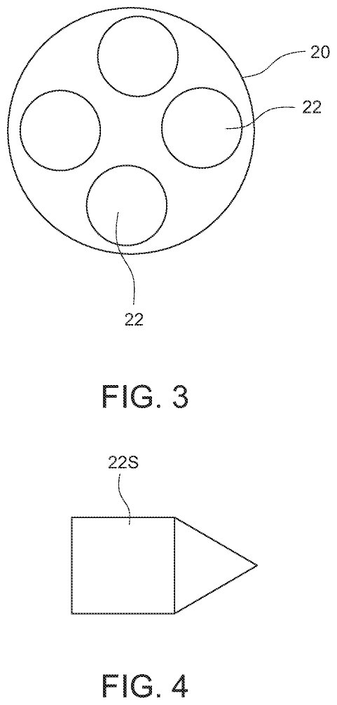

Referring to FIG. 1, a LEONIDAS launch system 10 is illustrated. The LEONIDAS launch system 10 includes a base 12 having multiple flexible limbs including cross-bow limbs 14 and recoil limbs 16. The LEONIDAS launch system 10 also includes a solar powered mechanical drive system 18 on the base 12 configured to position the cross-bow limbs 14 and the recoil limbs 16 in desired positions and a rotary magazine 20 (FIG. 3) on the base 12 configured to hold multiple sub-vessels 22 that are configured to perform different activities in space such as defense and salvage. The LEONIDAS launch system 10 also includes one or more launch cables 24 attached to the cross-bow limbs 14 configured to impart the launch power to the sub-vessels 22 during launch into low earth orbits (LEO). FIG. 4 illustrates a salvage sub-vessel 22S.

Referring to FIG. 2, a prototype LEONIDAS launch system 10P is illustrated. The prototype LEONIDAS launch system 10P includes cross-bow limbs 14P and recoil limbs 16P. The prototype LEONIDAS launch system 10P was manufactured using a NiTi alloy metal powder and an additive manufacturing to produce lightweight flexible limbs 14P, 16P. U.S. Pat. No. 9,925,591 B2, which is incorporated herein by reference, discloses exemplary cold hearth mixing systems and exemplary gas atomization systems for producing the NiTi alloy metal powder. Exemplary additive manufacturing systems can utilize a laser powder bed fusion (LPBF) system, a laser metal deposition (LIVID) system or an electron beam melting (EBM) system. One suitable additive manufacturing system includes a 3-D printer such as a modified EOS M100 3D-Printer manufactured by EOS GmbH Electro Optical Systems. In addition, powder production of titanium based shape-memory alloys has been performed by the Applicant, MolyWorks Materials Corporation of Los Gatos, Calif., using systems described in previously incorporated U.S. Pat. No. 9,925,591 B2.

One suitable NiTi alloy comprises NITINOL, which is known for its shape memory and superelastic properties. When deformed NITINOL can recover its original shape upon heating to above its transition temperature, with elasticity reaching up to thirty times higher than ordinary metal. Due to its high capacity for vibration damping, NITINOL has been researched by the Marshall Space Flight Center for use in the ISS (International Space Station). NITINOL recycling has been effectively demonstrated by the Applicant, MolyWorks Materials Corporation of Los Gatos, Calif.

Referring to FIG. 4, an operational method for the LEONIDAS launch system 10 is illustrated. Initially, the LEONIDAS launch system 10 can be launched into orbit via multi stage rocket or high altitude launch from an AIRBUS style jumbo jet. Once an optimal, stable orbit is achieved the LEONIDAS launch system 10 can be placed in a deploy mode using suitable signals. From its foothold in the exosphere, the LEONIDAS launch system 10 will have the ability to propel any of the sub-vessels 22 (FIG. 3) using renewable mechanical energy. The sub-vessels 22 can range in design and purpose as required. Exemplary sub-vessels include salvage sub-vessels, orbit modification microsatellite sub-vessels, and kinetic kill sub-vessels (and myriad iterations there between). The sub-vessels 22 (FIG. 3) can be stored in the rotary magazine 20 (FIG. 3), poised for selection and deployment as desired.

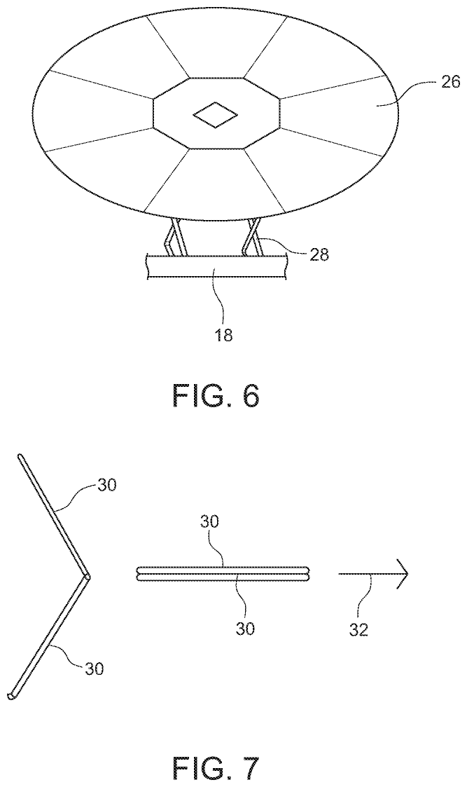

As shown in FIG. 6, solar energy can be collected using deployable solar cells 26 on flexible solar cell limbs 28. The flexible solar cell limbs 28 can be configured to retract for protection when unpowered, utilizing shape memory qualities to articulate the solar cells 26 passively upon undergoing thermal cycles due to solar radiation. Energy will be allocated by the solar powered mechanical drive system 18 to drive motors and retracting cams and other apparatus coupled to the flexible solar cell limbs 28 as well as the cross-bow limbs 14 (FIG. 1), and the recoil limbs 16 (FIG. 1).

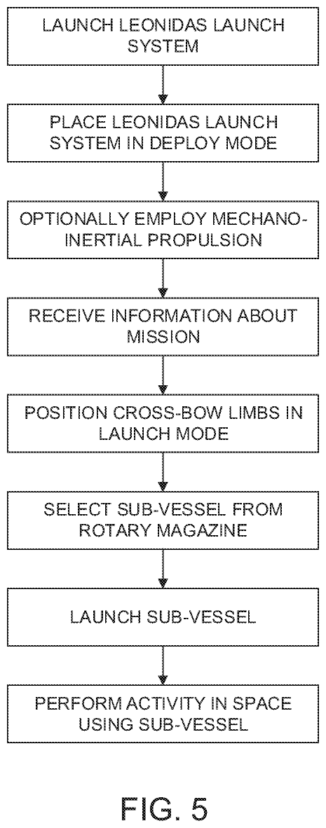

As shown in FIG. 7, the LEONIDAS launch system 10 can also include flexible propulsion limbs 30 generating locomotion in space by contraction then energy release in the desired direction of travel 32. The flexible propulsion limbs 30 can be operated during a propulsion mode as required. As shown in FIG. 5, this operational method step is designated as “optionally employ mechano-inertial propulsion”. Mechano-inertial propulsion (MIP) can function in the same way that a reaction wheel functions, with a gradual buildup of energy culminating in a sudden exchange, but in this case the forces are more directed and pronounced. In the same way that induce limb actuated inertial reflex (LAIR) can provide the possibility of a neutral impulse launch system, mechano-inertial propulsion (MIP) can utilize similar principals to provide an efficient, inexhaustible form of propulsion.

As also shown in FIG. 5, the operational method can also include the steps of receiving information about the mission to allow proper selection and launching of the sub-vessels 22. Using this information the cross-bow limbs 14 can be positioned in a launch mode. Once in position, a guide (not shown) accepts a sub-vessel 22 from the rotary magazine 20 (FIG. 3). Sub-vessel selection from the magazine 20 will depend upon specified mission role. The LEONIDAS launch system 10 can be configured to align with the anticipated trajectory of its target object using CMGs (Control Moment Gyroscope) and utilize a catch to release built-up limb tension and propel the selected vehicle toward its destination. During the launch mode, the correct arrangement of the recoil limbs 16 counteracts the negative impulse suffered by propelling the sub-vessels 22 in microgravity. This will induce limb actuated inertial reflex (LAIR), counteracting the impulse produced by the release of the sub-vessels 22. The magazines 20 can be resupplied and replenished via autonomous delivery, and the use of an on-board manipulator arm affixed to the LEONIDAS launch system 10.

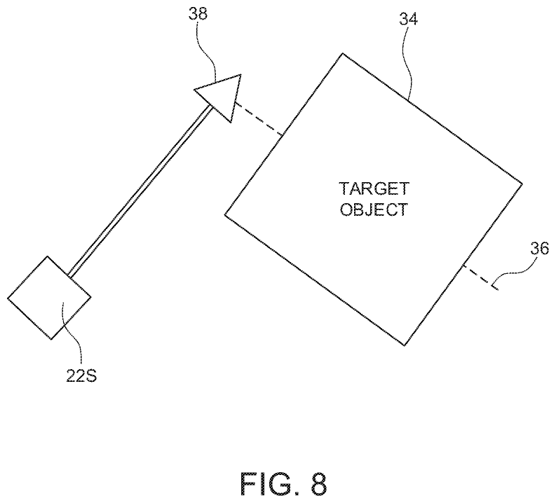

As also shown in FIG. 5, the operational method can also include the step of performing an activity in space using the sub-vessel 22. FIG. 8 illustrates and exemplary salvage operation using the salvage sub-vessel 22S. In this example, the salvage sub-vessel 22S can also include propulsion limbs 30 (FIG. 7), which for simplicity are not shown. In FIG. 8, a target object 34 has an orbit 36 in space. Upon arrival at the target object 34, the salvage sub-vessels 22S can couple using hot melt epoxy affixed to simple articulated manipulator pads 38, or direct physical connection using barbed darts or fishhooks. Other grappling methods involve epoxy or sticky lines deploying from a pressurized canister and enveloping the target object 34 like jellyfish tendrils, to be later removed by technicians during EVA salvage operation, or by solvent excreted from within grapple lines. Next, the process of propulsion to a safe point of salvage near the ISS can be performed. The propulsion process can be performed using mechano-inertial propulsion (MIP) as previously explained, in conjunction with a combination of reaction wheels, CMGs, RCS, and chemical thrust. During this process, the salvage sub-vessel 22S will effectively “tug” the retrieved target object 36 gradually through space. Multiple salvage sub-vessels 22S can be deployed to assist in target object 36 retrieval if object mass is too great or if time constraints are present.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A low Earth orbit neutral impulse defense and salvage (LEONIDAS) launch system comprising:
a base having a plurality of flexible limbs including cross-bow limbs configured to generate launch power and recoil limbs configured to eliminate recoil;
a solar powered mechanical drive system on the base configured to position the flexible limbs in selected positions;
a magazine on the base configured to hold multiple sub-vessels configured to perform different activities in space; and
one or more launch cables attached to the cross-bow limbs configured to impart the launch power to a selected sub-vessel retrieved from the magazine to launch the selected sub-vessel into low earth orbit with the recoil limbs balancing momentum transfer during the launch mode.

2. The LEONIDAS system of claim 1 further comprising a plurality of propulsion limbs for generating locomotion in space by contraction then energy release in a desired direction of travel.

3. The LEONIDAS system of claim 1 wherein the sub-vessels include a salvage sub-vessel.

4. The LEONIDAS system of claim 1 wherein the sub-vessels include a defense sub-vessel.

5. The LEONIDAS system of claim 1 wherein the flexible limbs comprise a NiTi alloy.

6. The LEONIDAS system of claim 1 wherein the flexible limbs comprise NITINOL.

7. The LEONIDAS system of claim 1 wherein the selected sub-vessel comprises a salvage sub-vessel configured to retrieve a target object in space.

8. The LEONIDAS system of claim 7 wherein the salvage sub-vessel includes a plurality of propulsion limbs.

9. The LEONIDAS system of claim 1 wherein the solar powered mechanical drive system includes at least one flexible solar cell limb configured to retract for protection when unpowered, utilizing shape memory qualities to articulate solar cells passively upon undergoing thermal cycles due to solar radiation.

10. A method for fabricating a low Earth orbit neutral impulse defense and salvage (LEONIDAS) launch system comprising:
producing a nickel-titanium alloy powder from a scrap material; and
producing a base comprised of flexible limbs having a desired configuration using the alloy powder and an additive manufacturing system, the flexible limbs including cross-bow limbs, recoil limbs and propulsion limbs.

11. The method of claim 10 wherein the additive manufacturing system comprises a system selected from the group consisting of laser powder bed fusion (LPBF) systems, laser metal deposition (LMD) systems and electron beam melting (EBM) systems.

12. The method of claim 10 wherein the alloy powder comprises NITINOL.
